(19) United States
(12) Patent Application Publication
(10) Pub. No.: US 2018/0339377 A1
(43) Pub. Date: Nov. 29, 2018

(54) Concentric Actuation and Reaction Torque Transfer System

(71) Applicants: Johannes P. Schneeberger, Brisbane, CA (US); John D. Davis, Riverton, UT (US)

(72) Inventors: Johannes P. Schneeberger, Brisbane, CA (US); John D. Davis, Riverton, UT (US)

(21) Appl. No.: 15/605,861

(22) Filed: May 25, 2017

(51) Int. Cl. B23P 19/06; F16B 39/24

(52) U.S. Cl. CPC B23P 19/06; F16B 39/24

(57) ABSTRACT

An actuation and reaction socket tool features a reaction coupling that is slid onto the spline flange of a power torque wrench prior to attaching the actuation socket on the drive shaft of the torque wrench and prior to securing it with a well known safety pin. The reaction coupling is then coupled to the reaction socket via circumferentially arrayed and interlocking castles on both the reaction coupling and reaction socket. A lock plate spring loaded snaps into grooves on the inside of the castles and axially locks the reaction coupling with the reaction socket. At least one of the reaction coupling and reaction socket is axially withheld by the central actuation socket such that the entire tool system remains connected to the torque wrench. To remove the tool again, the reaction coupling and reaction socket are first decoupled, which provides access again to the safety pin for its removal.

### FIELD OF INVENTION

The present invention relates to systems and tools for transferring an actuation torque on an actuation receiving structure while concentrically transferring a corresponding oppositely acting reaction torque onto a reaction receiving structure in the immediate vicinity of the actuation receiving structure. In particular, the present invention relates to concentric actuation/reaction socket tools for actuating nuts and/or bolt heads while transferring the corresponding reaction torque onto a reaction washer beneath that nut and/or bolt head.

### BACKGROUND OF INVENTION

Reaction washers are increasingly adopted in conjunction with larger size nuts and/or bolt heads that require powered torque wrenches to apply the necessary high actuation torques for tightening and loosening them. Reaction washers are conveniently placed in between the nut and/or bolt head to be tightened and the flange surface. They bite into the underneath flange surface while the nut and/or bolt head is tightened by the applied actuation torque. The resulting reaction torque is thereby concentrically and without any distorting side loads transferred from the torque wrench housing onto the flange body.

In the prior art, actuation and reaction sockets are combined and fixed on the power torque wrench commonly via a number of small screws. Changing to a different size nut and/or bolt head requires the number of small screws to be loosened and then tightened again. This is cumbersome, time consuming and particularly unfeasible in rough operating conditions. Moreover and as such combined actuation and reaction socket tools are desirably of minimum weight and size, the resulting elastic deformations tend to loosen the attachment screws, which requires continuous checking of them. Therefore, there exists a need for a concentric actuation and reaction torque transfer system that is compact and easily manually attached and detached from commercially available power torque wrenches without need for actuating any screws. The present invention addresses this need.

### SUMMARY

An actuation and reaction socket tool features a reaction coupling that is slid onto the spline flange of the power torque wrench prior to attaching the actuation socket on the drive shaft of the torque wrench and prior to securing it with a well known safety pin. The reaction coupling is then coupled to the reaction socket via circumferentially arrayed and interlocking castles on both the reaction coupling and reaction socket. A lock plate spring loaded snaps into grooves on the inside of the castles and axially locks the reaction coupling with the reaction socket. At least one of the reaction coupling and reaction socket is axially withheld by the central actuation socket such that the entire tool remains connected to the power torque wrench while the safety pin remains in place. To remove the tool from the power torque wrench, the reaction coupling and reaction socket are first decoupled, which provides access again to the safety pin for its removal.

### BRIEF DESCRIPTION OF THE FIGURES

FIG. 1 is a frontal cut view of the preferred embodiment of the invention in operational position.

FIG. 2 is a first perspective view of a reaction coupling of the preferred embodiment of the invention.

FIG. 3 is the first perspective view of the reaction coupling of FIG. 2 with a snap lock cover removed. Tangent edges are not shown for clarity.

FIG. 4 is a second perspective view of a reaction socket of the preferred embodiment of the invention.

### DETAILED DESCRIPTION

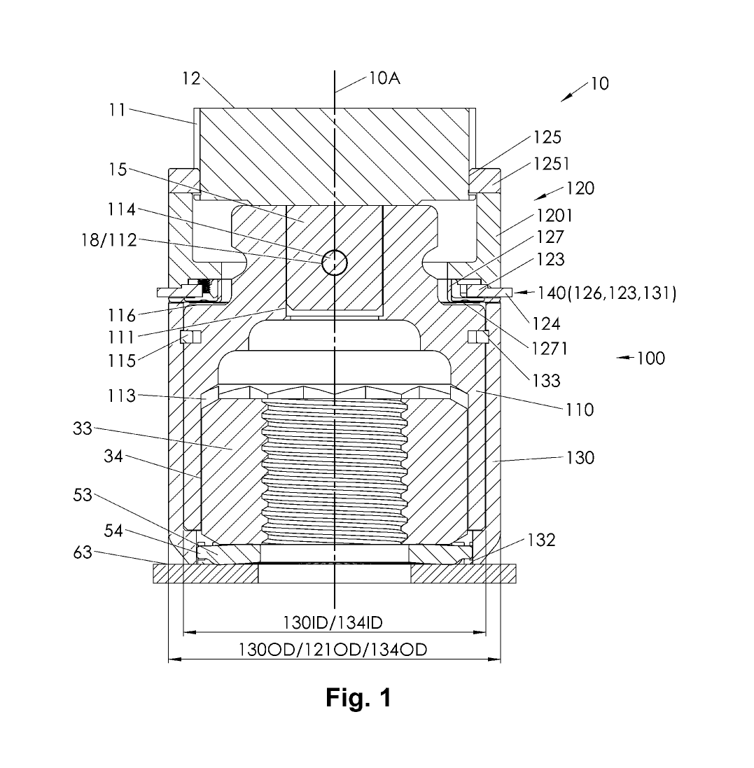

As in FIG. 1, a torque transfer system 100 for concentrically and simultaneously transferring an actuation torque and a reaction torque around a torque transfer axis 10A features an actuation socket 110, a reaction coupling 120 and a reaction socket 130. The actuation socket 110 has a drive shaft torque interface 111, an axial shaft lock interface 112, an actuation interface 113 and an axial retention feature in the form of snap ring 115 and/or a circumferential retention face 116.

In operational position, the actuation socket 110 is coupled with a drive shaft 15 of a torque wrench 10 via its drive shaft torque interface 111 that is correspondingly shaped and in a torque transferring mate with the contoured shape such as for example a square of the drive shaft 15 as is well known in the art. The actuation interface 113 such as for example but not limited to a hex, double hex, torax™, triple square, is thereby positioned substantially centrally and concentrically with respect to the torque transfer axis 10A and is facing away from the torque wrench 10 for transferring the actuation torque from the drive shaft 15 onto the actuation receiving structure 33 such as a nut and/or bolt head.

The actuation socket 110 is axially coupled to the drive shaft 15 via an axial shaft lock interface in the preferred configuration of a lock pin 114 engaging with a radial through hole 112 that is radially extending through the body of the actuation socket 110 and a radial shaft hole 18 that is radially extending through the drive shaft 15. The axial retention feature 115/116 is thereby axially positioned with respect to the torque wrench 10.

The reaction coupling 120 has a torque wrench interface 125 and a reaction socket interface 126. The torque wrench interface 125 may be in the preferred form of an internal spline 125 in a configuration that is mating preferably a spline flange 11 that may be part of a well known housing 12 of the torque wrench 10. The spline flange 11 may be positioned axially adjacent the drive shaft 15 and may be substantially concentric with respect to the torque transfer axis 10A. The torque wrench interface 125 is torque transferring and axially slide able coupled with the housing 12 in general but preferably with the spline flange 11. The reaction socket interface 126 becomes thereby positioned substantially concentric with respect to the torque transfer axis 10A and is facing away from the torque wrench 10.

The reaction socket 130 has a coupling interface 131 and a drain interface 132. While the reaction socket 130 is rotationally move able with respect to and substantially concentric surrounding the actuation socket 110, it is coupled with the reaction socket interface 126 via its coupling interface 131. Thereby, the drain interface 132 is substantially concentrically surrounding and axially adjacent the actuation interface 113. Consequently, the reaction torque is transferred from the housing 12 onto a reaction receiving structure 53 that may be positioned at least beneath but preferably also concentrically with respect to the torque transfer axis 10A around the actuation receiving structure 33. The reaction receiving structure 53 may be preferably a reaction washer 53, which in turn may transfer the received reaction torque onto a base flange 63.

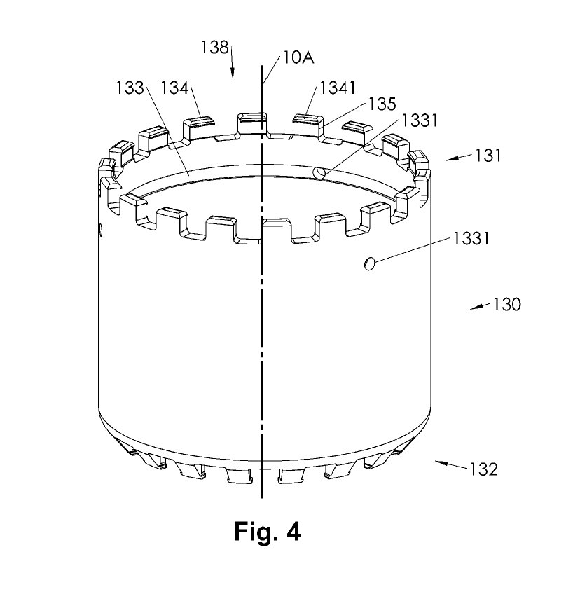

As also shown in FIG. 4 and in case of the axial retention feature 115 being the snap ring 115, the reaction socket 130 may have an internal circumferential snap groove 133 in which the snap ring 115 may snap in. Thereby, the reaction socket 130 may be axially secured with respect to the torque transfer axis 10A and onto the actuation socket 110. Snap ring access holes 1331 may radially extend through the body of the reaction socket 130 and may be circumferentially arrayed around the snap groove 133 to externally access and radially depress the snap ring 115. That way, the reaction socket 130 may be removed again from the actuation socket 110. The snap ring access holes 1331 may be threaded such that the radial inward displacement of the snap ring 115 may be accomplished by screwing in set screws or the like into the snap ring access holes 1331.

The axial retention feature 116 may alternately be a circumferential retention face 116 that may be facing towards the torque wrench 10. In that case, the reaction coupling 120 may have an axial stop face 1271. The axial stop face 1271 may be resting against the circumferential retention face 116 while the actuation socket 110 is axially secured on the drive shaft 15 and the reaction coupling 120 is coupled via its torque wrench interface 125 with the spline flange 11 of the housing 12.

The axial retention feature 114 may alternatively be provided by the radial lock pin 114 that may radially extend outside the radial pin hole 112 and underneath the axial stop face 1271 while assembled to axially secure the actuation socket 110 on the drive shaft 15. In that case and as may be clear to anyone skilled in the art, the reaction coupling 120 may be axially secured on the housing 12 by the axial stop face 1271 resting against the lock pin 114.

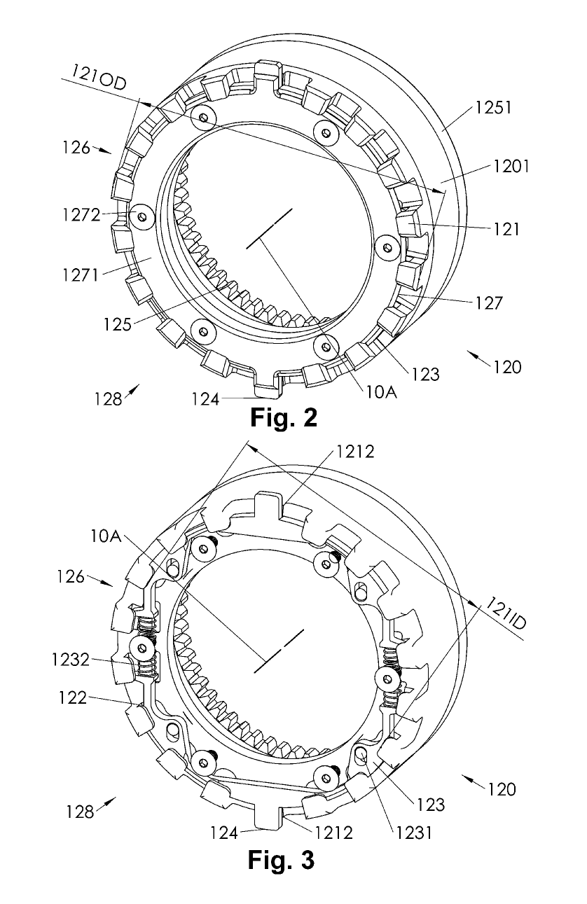

As further shown in FIGS. 2, 3, 4, the reaction socket interface 126 may be provided by a number of first castles 121 that are circumferentially arrayed at an end of the reaction coupling 120 and preferably radially dimensioned with a first outer castle array diameter 121OD that matches substantially an outer reaction socket body diameter 130OD. At the same time, the coupling interface 131 may be provided by a number of second castles 134 that are circumferentially arrayed at an end of the reaction socket 130 in mating opposition to the first castles 121. Likewise, the second castles 134 may be preferably radially dimensioned with an inner castle array diameter 134ID that matches substantially an inner reaction socket body diameter 130ID and an outer castle array diameter that matches substantially an outer reaction socket body diameter 130OD. Thereby, the coupling interface 131 is axially slide able and circumferentially interlocking with the reaction socket interface 126.

Employment of first and second castles 121, 134 and radial dimensioning 121OD, 134ID, 134OD of them in conjunction with the reaction socket body diameters 130ID, 130OD as well as the circumferentially opposite mating of first and second castles 121, 134 provides for a high structural strength and high transferable reaction torque from the reaction coupling 120 onto the reaction socket 130 while maintaining outer diameters 130OD, 134OD and inner diameters 130ID, 134ID substantially continuous all the way to the end of the reaction socket 130 including the coupling interface 131. This is advantageous on one hand for assembling the reaction socket 130 over the actuation socket 110 and on the other hand for keeping a maximum outer diameter of reaction coupling 120, reaction socket interface 126 and coupling interface 131 within the limits of reaction body diameters 130ID, 130OD. The reaction body diameters 130ID, 130OD may in turn be predetermined by structural needs for transferring a predetermined reaction torque within the reaction socket 130 body as may be clear to anyone skilled in the art.

First and second castles 121, 134 may have first and second internal recesses 122, 135 in the preferred configuration of first and second internal grooves 122, 135. At the same time, the reaction socket interface 126 may have a radial lock feature 123 in the preferred configuration of a lock plate 123. The preferably two lock plates 123 may be axially retained and radially slide able within the reaction socket 120 and in between a removable snap lock cover 127 and the reaction coupling body 1201. The lock plates 123 may be spring loaded forced via lock plate load springs 1232 into the first and second internal grooves 122, 135 while the reaction socket interface 126 is coupled with the coupling interface 131. Preferably, first and second internal grooves 122, 134 are axially with respect to the torque transfer axis 10A substantially aligned with each other while the reaction socket interface 126 is coupled with the coupling interface 131 such that the lock plates 123 may be of continuous thickness in between first and second castles 121, 134. The lock plates 123 thickness may preferably correspond to the axial height of the first and second internal grooves 122, 134.

The lock plates 123 have each an externally accessible actuator 124 that is circumferentially aligned with a respective one reduced height castle 1212. The actuator 124 is extending radially outward beyond the outer first and second outer castle array diameters 121OD, 134OD. Thereby, the reaction socket interface 126 may be coupled with the coupling interface 131 in any circumferential oppositely mating orientation to each other unimpeded by the actuators 124.

The preferably two lock plates 123 are positioned rotationally symmetric with respect to the torque transfer axis 10A such that the snap interlock between the reaction socket interface 126 and the coupling interface 131 is circumferentially evenly distributed between them. The lock plates 123 may be radially guided by lock plate guide pins 1231 as my be clear to anyone skilled in the art. The snap lock cover 127 may be held onto the reaction coupling body 1201 via cover screws 1272. The snap lock cover 127 may also provide the axial stop face 1271. The first inner castle array diameter 121ID may be substantially reduced below the second inner castle array diameter 134ID to provide sufficient radial depth of the first internal grooves 122 such that the lock plates 123 remain axially guide within them over their entire radial movement range.

The internal spline 125 may be provided by a spline ring 1251 axially attached at the end of the reaction coupling 120 that is opposite the reaction socket interface 126. That way, the reaction coupling 120 may be conveniently adapted to different spline flanges 11.

All parts of the concentric actuation and reaction torque transfer system 100 may be fabricated from steel or any other material suitable for transferring predetermined high torque loads. To apply an actuation torque to a predetermined actuation torque receiving structure 34 and to concurrently drain the corresponding reaction torque onto an axially adjacent reaction torque receiving structure 53, an actuation socket 110 and reaction socket 130 with correspondingly shaped actuation and drain interfaces 113, 132 are selected. A reaction coupling 120 may be initially coupled with the spline flange 11 followed by coupling the actuation socket 110 with the drive shaft 15.

In case of actuation and reaction torque receiving structures 34, 53 having standardized shapes, a snap ring 115 may be employed and actuation and reaction socket 110, 130 may be selected as a preassembled set. In that case, actuation and reaction sockets 110, 130 may be together already while the actuation socket 110 is attached to the drive shaft 15. Alternately, the reaction socket 130 may consecutively be slid over the actuation socket 110 following the coupling and attachment of the actuation socket 110 onto the drive shaft 15. The reaction socket 130 may be rotationally oriented such that its second castles 134 face the gaps in between the first castles 121. The reaction coupling 120 may be then axially slid along the spline flange 11 such that reaction socket interface 126 engages with coupling interface 131. During coupling, lock plate displacement chamfers 1341 along the inner top edges of the second castles 134 may force the lock plates 123 radially inward until they give way for the second castles 134 to bottom out in between the first castles 121. At that moment, the second internal grooves 135 become aligned with the first internal grooves 122 and the lock plates 123 spring back and lock into both first and second internal grooves 122, 135. Thereby, a direct axial lock is established between first and second castles 121, 135 across the lock plates 123.

In case of an axial stop face 1271 being employed instead of a snap ring 115, The axial stop face 1271 resting against the lock pin 114 or the circumferential retention face 116 may keep the reaction coupling 120 and attached reaction socket 130 axially on to the torque wrench 10. The torque transfer system 100 is now ready to be put in position together with the attached torque wrench 10 over the predetermined actuation and reaction torque receiving structures 34, 53.

To disassembly the reaction socket 130 again, the actuators 124 are externally accessed and manually depressed, whereby the lock plates 123 are moved radially inward and the second castles 135 axially released. While the actuators 124 are kept depressed, the reaction socket 130 may be separated from the reaction coupling 120 and the entire torque transfer system removed from the torque wrench 10 in the following without having to loosen any screws.

Irrespective the preferred employment of the ring snap coupling 140 including the reaction socket interface 126, the coupling interface 131 and the radial lock feature 123 in conjunction with the concentric actuation and reaction torque transfer system 100, the ring snap coupling 140 may be independently employed to provide coupling of any two structures 120, 130 as described for the reaction socket 120 and reaction socket 130. The reaction socket interface 126 may thereby be any first coupling interface 126 at a first coupling end 128 of a first structure 120 and the coupling interface 131 may thereby be any second coupling interface 126 at a second coupling end 138 of a second structure 130.

Accordingly, the scope of the present invention is set forth by the following claims and their legal equivalent:

What is claimed is:

1. A concentric actuation and reaction torque transfer system comprising:
a. a torque transfer axis;
b. an actuation socket comprising:
i. a drive shaft torque interface;
ii. an axial shaft lock interface;
iii. an actuation interface;
iv. an axial retention feature;
wherein and while said actuation socket is being coupled with a torque wrench drive shaft via said drive shaft torque interface, said actuation interface is positioned substantially centrally and concentrically with respect to said torque transfer axis and is facing away from said torque wrench for transferring said actuation torque from said drive shaft onto an actuation receiving structure; and
wherein and while said actuation socket is axially coupled to said drive shaft via said axial shaft lock interface, said axial retention feature is axially positioned with respect to said torque wrench;
c. a reaction coupling comprising a torque wrench interface and a reaction socket interface, wherein and while said torque wrench interface is torque transferring and axially slide able coupled with a housing of said torque wrench, said reaction socket interface is substantially concentric with respect to said torque transfer axis and is facing away from said torque wrench; and
d. a reaction socket comprising a coupling interface and drain interface, wherein and while said reaction socket is rotationally move able with respect to said actuation socket positioned around said actuation socket:
i. said coupling interface is torque transferring coupled with said reaction socket interface;
ii. said drain interface is facing away from said torque wrench; and
iii. said drain interface is substantially concentrically surrounding and axially adjacent said actuation interface for transferring said reaction torque from said housing onto a reaction receiving structure that is positioned beneath said actuation receiving structure.

2. The concentric actuation and reaction torque transfer system of claim 1, wherein said reaction socket further comprises an internal circumferential snap groove and wherein said axial retention feature is comprised of a snap ring that is snapping in said internal circumferential snap groove.

3. The concentric actuation and reaction torque transfer system of claim 1, wherein said reaction coupling further comprises an axial stop face that is facing away from said torque wrench and wherein said axial retention feature is comprised of an circumferential retention face that is facing towards said torque wrench such that said axial stop face is resting against said circumferential retention face and such that said reaction coupling is withheld from disconnecting from said torque wrench while said actuation socket is axially secured on said drive shaft and said torque wrench interface is coupled with said housing.

4. The concentric actuation and reaction torque transfer system of claim 1, wherein said reaction coupling further comprises an axial stop face that is facing away from said torque wrench and wherein said axial retention feature is comprised of a lock pin that is radially extending through said drive shaft and said actuation socket such that said axial stop face is resting against said lock pin and such that said reaction coupling is withheld from disconnecting from said torque wrench while said actuation socket is axially secured on said drive shaft and said torque wrench interface is coupled with said housing.

5. The concentric actuation and reaction torque transfer system of claim 1, wherein said torque wrench has a spline flange that is concentric with and substantially axially continuous with respect to said torque transfer axis, and wherein said torque wrench interface comprises in internal spline that is mating said spline flange for transferring said reaction torque and that is axially slide able along said spline flange such that said reaction coupling is axially with respect to said torque transfer axis slide able along said spline flange while said reaction socket interface is being axially coupled with said coupling interface.

6. The concentric actuation and reaction torque transfer system of claim 1, wherein said reaction socket interface comprises a number of first castles that are circumferentially array at an end of said reaction coupling, wherein said coupling interface comprises a number of second castles that are circumferentially arrayed at an end of said reaction socket in mating opposition to said first castles such that coupling interface is axially slide able and circumferentially interlocking with said reaction socket interface.

7. The concentric actuation and reaction torque transfer system of claim 6, wherein said number of first castles is radially dimensioned with a first outer castle array diameter that matches substantially an outer reaction socket body diameter and wherein said number of second castles is radially dimensioned with a second inner castle array diameter that matches substantially an inner reaction socket body diameter and an outer castle array diameter that matches substantially an outer reaction socket body diameter.

8. The concentric actuation and reaction torque transfer system of claim 6, wherein at least one castle of said first circumferential castle array comprises a first internal recess and at least one other castle of said second circumferential castle array comprise a second internal recess, and wherein said reaction socket interface further comprises a radial lock feature that is axially retained and radially slide able held within said reaction coupling and that is spring loaded forced into said first internal recess and said second internal recess while said reaction socket interface is coupled with said coupling interface.

9. The concentric actuation and reaction torque transfer system of claim 8, wherein said first internal recess is comprised of a first internal groove and said second internal recess is comprised of a second internal groove that is axially substantially aligned with said first internal circumferential groove while said reaction socket interface is coupled with said coupling interface, and wherein said radial lock feature is comprised of a lock plate.

10. The concentric actuation and reaction torque transfer system of claim 9, wherein said lock plate comprises an externally accessible actuator that is extending radially outward beyond an outer first castle diameter and that is circumferentially aligned with a height reduced one of said first castle such that said reaction socket interface may be coupled with said coupling interface in any circumferential oppositely mating orientation to each other unimpeded by the externally accessible actuators.

11. The concentric actuation and reaction torque transfer system of claim 1, wherein said actuation socket and said reaction socket are a preassembled set.

12. A ring snap coupling comprising:
a. a torque transfer axis;
a. a first coupling interface comprising:
i. a first coupling end;
ii. a number of first castles that are arrayed circumferentially with respect to said coupling axis along and around said first coupling end, and that are extending axially with respect to said coupling axis away from said first coupling end, wherein at least one of said first castles comprises a first internal radial recess;
iii. a radial lock feature that is outward spring loaded guided within said first internal radial recess;
b. a second coupling interface comprising:
i. a second coupling end;
ii. a number of second castles that are arrayed oppositely mating said first castles and circumferentially with respect to said coupling axis along and around said first coupling end , and that are extending axially with respect to said coupling axis away from said second coupling end, wherein at least one of said second castles comprises a second internal radial recess; and
wherein and while said first and said second castles are circumferentially interlocking and axially bottoming coupled, said radial lock feature is radially outward engaging with said second internal radial recess.

13. The ring snap coupling of claim 12, wherein said first and said second internal radial recesses are axially substantially aligned while said first and second castles are circumferentially fully interlocking, and wherein said radial lock feature comprises a lock plate of a lock plate height that corresponds substantially to a groove height of said first and second internal radial recesses.

14. The ring snap coupling of claim 12, wherein said radial lock feature comprises an externally accessible actuator that is radially outward extending beyond an outer coupling diameter of said ring snap coupling within an overall axial first height of said first castles and circumferentially aligned with a reduced height one of said first castles such that said first and second castles are circumferentially interlocking and axially bottoming coupled unimpeded by said externally accessible actuator.
